(19) United States
(12) Patent Application Publication
(10) Pub. No.: US 2023/0370412 A1
(43) Pub. Date: Nov. 16, 2023

(54) Method and system of two-way communication between author and addressee of anonymous message

(71) Applicants: Davit Harutyunyan, Yerevan (AM); Vahan Harutyunyan, Yerevan (AM)

(72) Inventors: Davit Harutyunyan, Yerevan (AM); Vahan Harutyunyan, Yerevan (AM)

(21) Appl. No.: 18/300,229

(22) Filed: Apr. 13, 2023

Related U.S. Application Data
(60) Provisional application No. 63/330,360, filed on Apr. 13, 2022.

(51) Int. Cl. H04L 51/48; H04L 9/40; H04L 51/226

(52) U.S. Cl. CPC H04L 51/48; H04L 63/0421; H04L 51/226

(57) ABSTRACT

Computer systems and methods for two-way communication between the author and the addressee of an anonymous initial message are provided. An anonymous initial message (for example: offering or inquiry) of any type is sent by one person (sender) to another person (recipient). The message is delivered to the recipient without disclosing the identity of the sender. The recipient may reply to one or more persons specified by such recipient. Various replies may be sent to various persons. A reply will not be delivered to its addressee if such addressee is not the sender of the original anonymous message.

### PRIORITY CLAIMS AND CROSS-REFERENCE TO RELATED APPLICATIONS

This application is related to and claims domestic priority benefits under 35 USC § 119(e) from U.S. Provisional Patent Application Ser. No. 63/330,360 filed on Apr. 13, 2022, the entire contents, of the aforementioned application, are expressly incorporated hereinto by reference.

### FIELD OF THE INVENTION

The present invention relates to computer networks and in particular to computer systems and methods of communication between users of such networks.

### BACKGROUND

There are many everyday situations that benefit from the ability of a person to send a message to another person anonymously. This is especially true when a person avoids communicating with another person because of shyness, risk aversion, fear of rejection, societal pressures or constraints or other reasons. It is even rather common that two persons may be happy to communicate, but neither of them dares to make the first step. A possibility to initiate communication anonymously may help overcome such a barrier.

Various methods have been proposed for establishing communication based on anonymous messaging.

For example, in patent U.S. Pat. No. 5,950,200A a method and apparatus were proposed for automating the process of confidentially determining whether people feel mutual attraction or have mutual interests and for automating the process of notifying the people involved of such a match in feelings or interests, while allowing anonymity if no mutual attraction or interests exist. A computer system receives inputs from various persons indicating the identities of persons for whom they feel attraction or with whom they share mutual interests. The system collects this information and periodically searches for matches, i.e., for mutual attractions or interests that have been entered into the system. No notification occurs unless the system determines that a match in attraction or interests exists. If a first person's feelings or interests are not mirrored by a second person, the system will not notify either person and only the computer system will be aware of the first person's feelings for the second person.

A shortcoming of that patent is that users may indicate only a pre-determined type of feeling (“love”, “like”, “desire”) in relation to others, and the system searches for the matches based on the entries made by the users, while in real life, on one hand, a user (sender) may wish to send to another user (recipient) a free-form anonymous message not limited to any pre-determined options, and receive a reply to the message sent to the recipient.

In patent publication US20140136617A1, a method of a one-way anonymous communication system was proposed. In this method an anonymous initial message of any type is sent from the first user to the second user. The message is delivered to the second user without specifying any details about the sender. The second user may send a response, which will be delivered to the first user, who will remain anonymous to the second user.

A shortcoming of that patent publication is that the response of the recipient of an anonymous message is not person-specific (i.e. the recipient responds to the anonymous sender irrespective of who such sender might be), while the recipient might choose to respond to the particular sender differently, if at all, had he/she known who was the sender.

One of the objects of the present disclosure is to give to the recipient of an anonymous message an opportunity to make a targeted person-specific response, as if it was known to the recipient who was the sender of such message.

### DETAILED DESCRIPTION

The present disclosure provides a method and computer system for connecting people by giving the possibility to one person (sender) to send an anonymous message to another person (recipient), and giving the recipient the possibility to decide how to respond to such anonymous message (ignore, block, reply) depending on who the sender of such anonymous message was.

In a preferred embodiment of the present disclosure the sender sends a message of any type (e.g. an offering or an inquiry) addressed to the recipient to a computer system, which anonymously relays such message to the recipient. The recipient, after receiving such anonymous message, may take no action (i.e. ignore the anonymous message) or take one of the following steps:
(a) send one or more replies addressed to the users specified by the recipient (e.g. identified by user name);
(b) send one or more replies indicating the criteria to which the addressees of such replies should meet (e.g. gender, age, geographic location) and setting out priority levels for applying such criteria;
(c) send a reply addressed to the anonymous sender, whoever he/she is;
(d) any combination of a, b and c.

The computer system will take the following steps:
(aa) a reply received in accordance with step (a), if any, will be relayed to the sender only if the sender is an addressee of such reply;
(bb) if no reply was relayed to the sender in accordance with step (aa), a reply received in accordance with step (b), if any, will be relayed to the sender only if the sender meets the criteria set out for such reply. If the sender meets the criteria set out for more than one reply received in accordance with step (b), only the reply with the highest level of priority of its criteria will be relayed to the sender;
(cc) the reply received in accordance with step (c), if any, will be delivered to the sender if no reply was delivered to the sender in accordance with steps (aa) and (bb).

Various additional features may further be offered to the sender and/or the recipient to enhance their user experience. In particular:
(i) the recipient may indicate that he/she does not want to receive anonymous messages whatsoever or in case they contain certain words or phrases (e.g. “sex”, “love”, etc.),
(ii) the recipient may indicate that he/she does not want to receive anonymous messages from a particular person or from persons meeting or not meeting specific criteria (e.g. gender, age, geographic locations, not being in the recipient's contact list, etc.), or the sender of a particular anonymous message;
(iii) the sender may be notified that his/her anonymous message has been delivered to and/or read by the recipient;
(iv) the recipient may be notified that his/her reply has been delivered to and/or read by the sender with or without disclosing to the recipient the identity of the sender;
(v) the sender may be notified that he/she has been blocked by the recipient;
(vi) the sender may indicate an expiry time for his/her anonymous message upon expiration of which the recipient will not be able to respond to such anonymous message, and optionally the recipient may be informed about the time remaining to the expiration;
(vii) the messages may form a thread, until the sender and/or the recipient closes the thread.

The method provided by the present disclosure may be used in conjunction with and/or be implemented as an additional functionality of an online social network (e.g., Facebook®, Twitter®, LinkedIn® etc.) or a telecommunications application or a messenger (e.g. Telegram®, Signal®, Viber®, Skype®, WhatsApp®, Slack®, etc.) or a custom software application or part of another software or special-purpose hardware (e.g., circuitry) or a firmware or any combination thereof.

The present disclosure may utilize standard communications technologies and/or protocols or may use encryption using conventional (e.g. secure sockets layer SSL, transport layer security TLS, etc.), non-conventional or end-to-end encryption E2EE technologies.

### BRIEF DESCRIPTION OF THE DRAWINGS

Embodiments of the present disclosure will be described and explained through the use of the accompanying drawings in which:

FIG. 1A-FIG. 1D are diagrams illustrating the communication between the sender and the recipient in case the sender happens to be among the persons to whom the recipient has chosen to send a person-specific reply.

FIG. 2 is a flowchart with a set of operations to be performed by a computer system implementing a certain preferred embodiment of the present disclosure.

Some components and/or operations in the figures may be separated into different blocks or combined into a single block for the purposes of implementation of some of the embodiments of the present disclosure. Moreover, while the disclosure is amenable to various modifications and alternative forms, specific embodiments have been shown by way of example in the drawings and are described in detail below. The intention, however, is not to limit the disclosure to the particular embodiments described. On the contrary, the disclosure is intended to cover all modifications, equivalents, and alternatives falling within the scope of the disclosure as defined by the appended claims.

### DETAILED DESCRIPTION OF THE DRAWINGS

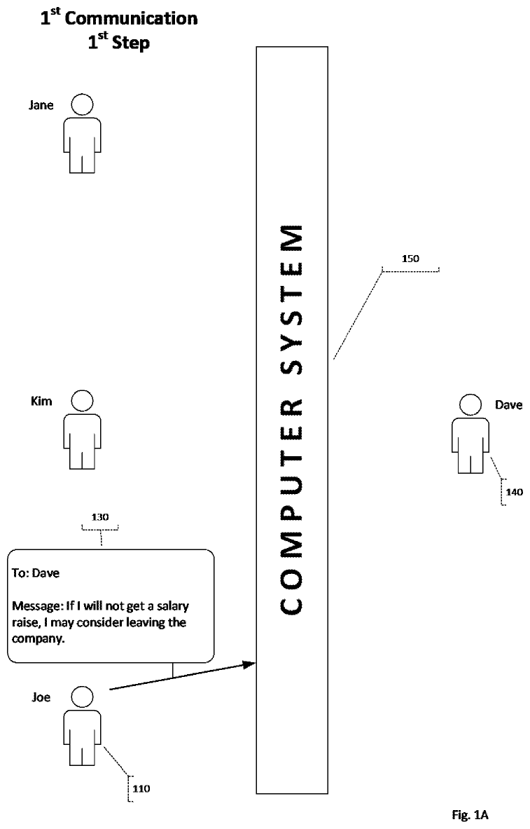

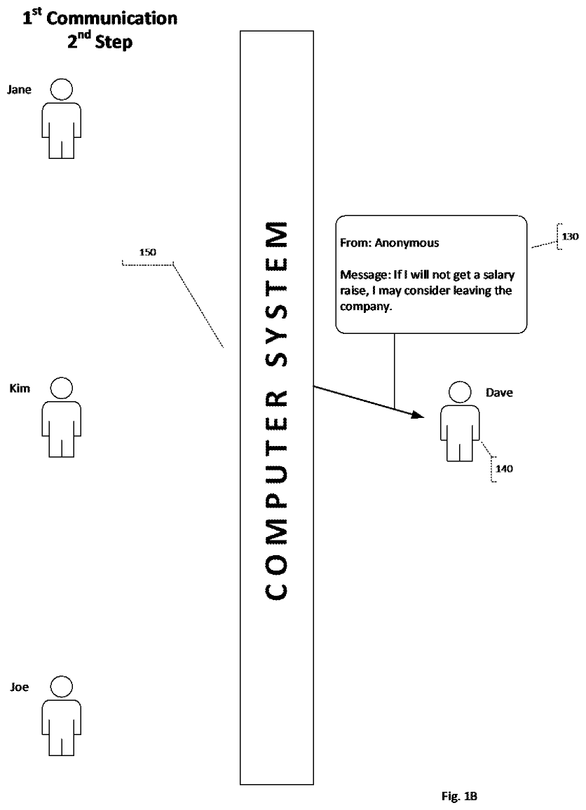

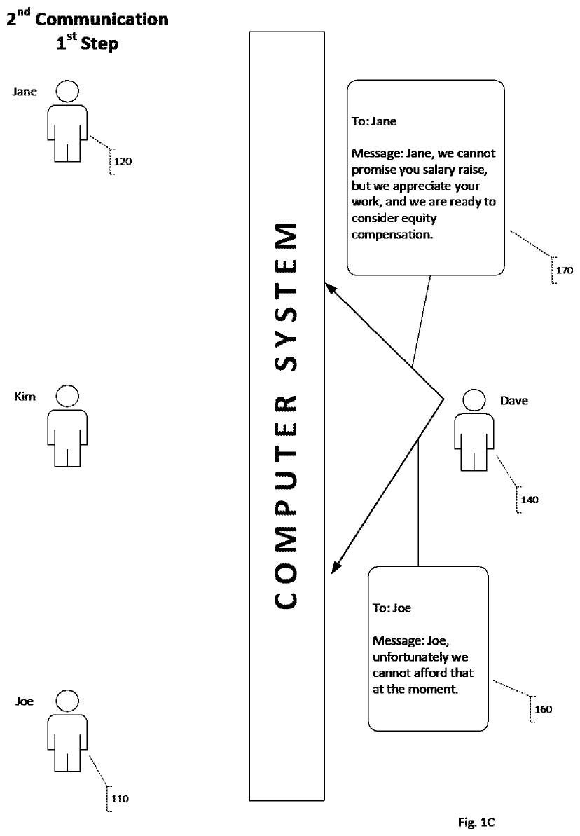

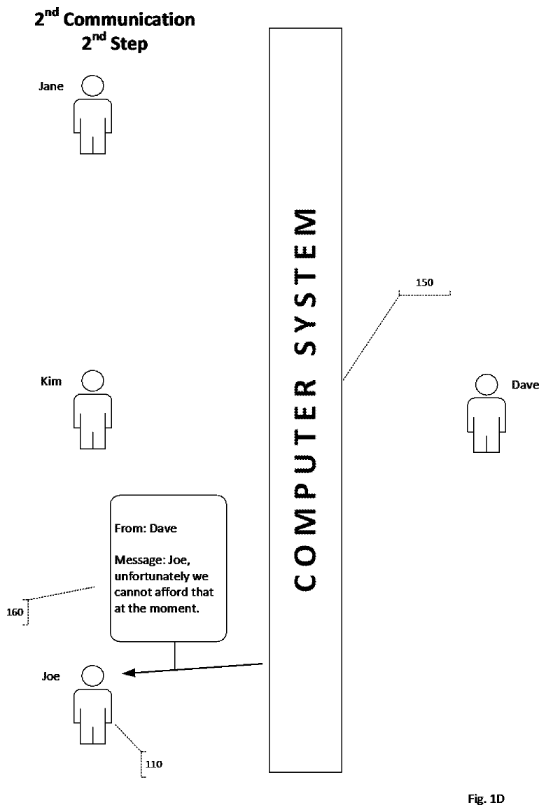

FIGS. 1A, 1B, 1C and 1D are diagrams illustrating the communication between the sender and the recipient via a computer system where the recipient sends replies addressed to two different users, one of whom happens to be the actual sender of the original anonymous message.

On FIG. 1A user 110 (sender) sends to computer system 150 message 130 addressed to user 140 (recipient).

On FIG. 1B computer system 150 anonymously relays message 130 to user 140.

On FIG. 1C user 140 responds to user 110 with reply 160 and to user 120 with reply 170.

On FIG. 1D computer system 150 analyzes the addressees of replies 160 and 170 received from user 140 to determine whether any such addressee is the sender, and relays reply 160 to user 110 because user 110 is determined by computer system 150 as the sender of the original anonymous message. Reply 170 is discarded.

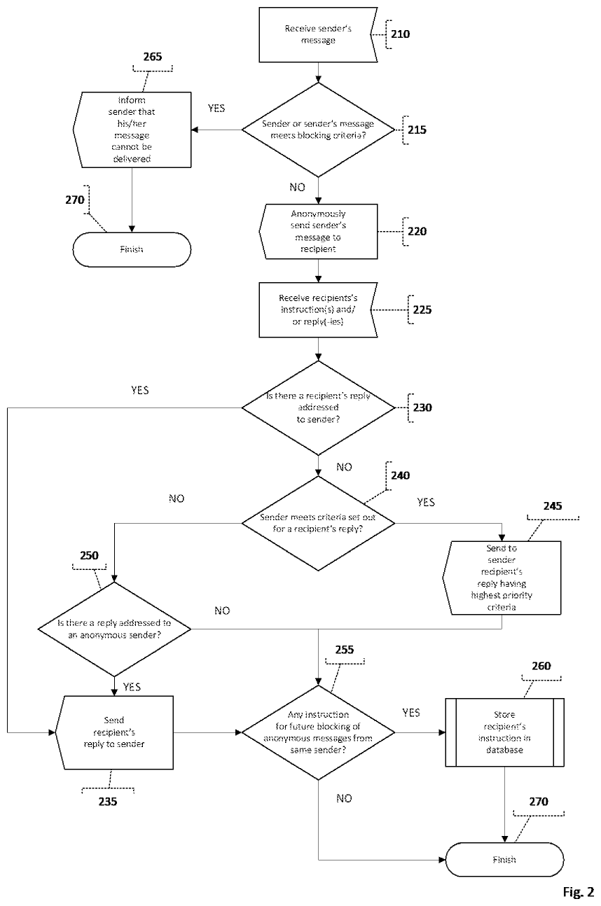

FIG. 2 is a flowchart with a set of operations that may be used with one or more embodiments of the present disclosure

As illustrated in FIG. 2, input operation 210 receives a message from the sender.

Decision operation 215 checks whether or not the sender's anonymous message is allowed to be sent to the recipient.

If the message is allowed to be sent to the recipient, output operation 220 anonymously relays the message to the recipient.

If a message is not allowed to be sent to the recipient (e.g. the sender has been blocked by the recipient or contains a taboo word), output operation 265 informs the sender that his/her message cannot be sent to the recipient and then steps to operation 270 which finishes the job.

Input operation 225 receives instruction(s) and/or reply(-ies) from the recipient. Such instructions may include one or more of the following:
A. one or more reply messages addressed respectively to one or more users specified by the recipient (e.g. identified by user name);
B. one or more reply messages with indication of the criteria, to which the addressee of each such reply should meet, and priority level of such criteria;
C. a reply message addressed to the anonymous sender, whoever he/she is, i.e. without indication of sender's identity or any criteria, to which the sender should meet;
D. an instruction to block delivery of anonymous messages from the same sender in the future.

Decision operation 230 checks whether there is a reply addressed to the sender of the original anonymous message.

If there is a reply addressed to the sender, then output operation 235 relays the relevant reply to the sender and then steps to decision operation 255.

If there is no reply addressed to the sender, then decision operation 240 checks for each reply whether the sender meets the criteria set out by the recipient for such reply.

If the sender meets the criteria set out by the recipient for such reply, then output operation 245 relays to the sender the recipient's relevant reply having the highest criteria priority level and then steps to decision operation 255.

If the sender does not meet the criteria set out by the recipient for such reply, then decision operation 250 checks whether there is a reply addressed to the anonymous sender, whoever he/she is.

If there is a reply addressed to the anonymous sender, then the output operation 235 relays the relevant reply to the sender and then steps to decision operation 255.

If there is no reply addressed to the anonymous sender, then decision operation 255 is performed.

Decision operation 255 checks whether the recipient has given an instruction to block further anonymous messages from the same sender.

If the recipient has given an instruction to block further anonymous messages from the same sender, then operation 260 stores the recipient's instruction in the database and steps to operation 270 which finishes the job.

If the recipient has not given an instruction to block further anonymous messages from the same sender, then operation 270 finishes the job.

What is claimed is:

1. A computer implemented method of communication between users via an electronic communication system, comprising the steps of:
receiving a message from one user addressed to a second user, such users respectively referred to as sender and recipient;
delivering the message of the sender to the recipient without disclosing to the recipient the identity of the sender;
receiving from the recipient one or more reply messages addressed respectively to one or more users, identified by user name;
determining whether or not any reply message of the recipient was addressed to the sender; and
based on the determining step of whether or not any reply message of the recipient was addressed to the sender, delivering the respective message to the sender.

2. (canceled)

3. A computer implemented method, comprising the steps of:
receiving a message from a sender addressed to a recipient;
delivering the sender's message to the recipient while keeping the sender's identity undisclosed;
receiving one or more reply messages from the recipient, together with the criterion to which the addressee of each reply should correspond and the priority assigned to each such criterion, wherein a criterion that is based on username will always have the highest priority compared to other criteria, and a criterion anonymously referring to the sender, whoever the sender is, will always have the lowest priority;
if the sender corresponds to the criterion set out for only one reply message received from the recipient, delivering that particular message to the sender; and
if the sender corresponds to the criteria set out for more than one reply messages received from the recipient, delivering to the sender the message having the highest priority criterion.

4. The computer implemented method according to claim 1, additionally comprising the steps of:
enabling the recipient to block anonymous messages based on one or more criteria relating either to the sender or the content of the message; and
blocking anonymous messages based on the criteria set out by the recipient in relation to the sender or the content of the message.

5. (canceled)

6. The computer implemented method according to claim 1, wherein the messages are sent with end-to-end encryption.

7. A computer system comprising one or more servers, each comprising a processor, memory and communication interface, connectable by user devices via wired or wireless lines of electronic communication, one or more databases connectable by such servers or user devices, and software applying the method of claim 1.

8. The computer system of claim 7, wherein the software further implements an additional method step of sending messages with end-to-end encryption.

9. The computer implemented method according to claim 6, further comprising the steps of:
enabling the recipient to block anonymous messages based on one or more criteria relating either to the sender or the content of the message; and
blocking anonymous messages based on the criteria set out by the recipient in relation to the sender or the content of the message.

10. The computer system of claim 7, wherein the software further implements additional method steps of:
enabling the recipient to block anonymous messages based on one or more criteria relating either to the sender or the content of the message; and
blocking anonymous messages based on the criteria set out by the recipient in relation to the sender or the content of the message.

11. The computer system of claim 8, wherein the software further implements additional method steps of:
enabling the recipient to block anonymous messages based on one or more criteria relating either to the sender or the content of the message; and
blocking anonymous messages based on the criteria set out by the recipient in relation to the sender or the content of the message.

12. The computer implemented method according to claim 3, additionally comprising the steps of:
enabling the recipient to block anonymous messages based on one or more criteria relating either to the sender or the content of the message; and
blocking anonymous messages based on the criteria set out by the recipient in relation to the sender or the content of the message.

13. The computer implemented method according to claim 3, wherein the messages are sent with end-to-end encryption.

14. A computer system comprising one or more servers, each comprising a processor, memory and communication interface, connectable by user devices via wired or wireless lines of electronic communication, one or more databases connectable by such servers or user devices, and software applying the method according to claim 3.

15. The computer system of claim 14, wherein the software further implements an additional method step of sending messages with end-to-end encryption.

16. The computer implemented method according to claim 13, further implementing additional method steps of:
enabling the recipient to block anonymous messages based on one or more criteria relating either to the sender or the content of the message; and
blocking anonymous messages based on the criteria set out by the recipient in relation to the sender or the content of the message.

17. The computer system of claim 14, wherein the software further implements additional method steps of:
enabling the recipient to block anonymous messages based on one or more criteria relating either to the sender or the content of the message; and
blocking anonymous messages based on the criteria set out by the recipient in relation to the sender or the content of the message.

18. The computer system of claim 15, wherein the software further implements additional method steps of:
enabling the recipient to block anonymous messages based on one or more criteria relating either to the sender or the content of the message; and
blocking anonymous messages based on the criteria set out by the recipient in relation to the sender or the content of the message.
